(19) United States
(12) Patent Application Publication
(10) Pub. No.: US 2003/0221568 A1
(43) Pub. Date: Dec. 4, 2003

(54) Combined printing machine

(76) Inventors: Josef Schneider, Diedorf-Lettenbach (DE); Peer Dilling, Friedberg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/276,384

(22) PCT Filed: Apr. 28, 2001
(86) PCT No.: PCT/EP01/04801

(30) Foreign Application Priority Data
May 16, 2000 (DE) 100236898

(51) Int. Cl. B41F 5/16; B41F 5/18

(52) U.S. Cl. 101/177

(57) ABSTRACT

The invention relates to a printing machine for multicolour printing, in which all printing units are configured in the same manner. Said machine is provided with a feed system for printable matter, which is suitable for both sheet-type and web-type printable matter. The printable matter can be connected to the feed system for printable matter in correct alignment and transported through all printing units (1-4) of the printing machine, using appropriate devices. The machine is provided with a transport belt, as the feed system for printable matter. Said belt is fed in a straight line through all the printing zones of the printing units (1-4) and is assigned to the printing cylinders (7). The transport belt can be attached to the printable matter by means of adhesion, contact pressure, application or using retaining strips.

### DESCRIPTION

The invention pertains to a device according to the preamble of claim 1.

### PRIOR ART

In printing machines for various printing methods, it is common practice to provide sheet transport means that allow a linear transport of substrates to be printed through the printing units from the feed station to the delivery station. Some of these methods and devices utilize grippers. Other methods and devices utilize conveyor belts that are linearly guided through the printing units for transporting the sheet-like materials.

DE 19527264 A1 discloses a printing machine with a linear substrate guide. In this case, the transport path of the substrates should extend linearly from the feed stack to the transport means in the plane of the transport path through the printing units. A conveyor belt is provided which transports the substrates between the cylinders of the printing units, e.g., by means of a frictional engagement. However, this publication contains no information regarding retention of the sheets on the conveyor belt with correct registration.

DE 19921271 A1 discloses a method for transporting sheets through a printing machine, as well as a device for carrying out said method. In this case, instead of grippers, regions that are coated with an adhesive are provided on the sheet guiding elements, with said adhesive-coated regions making it possible to guide the sheets while they are secured in position. This publication also describes a printing machine in which printable matter is linearly transported through the printing machine by means of a conveyor belt. This publication also contains a reference to the fact that retention of the sheet by means of electrostatic charges is not sufficient for transport of the sheets.

The invention aims to develop a variable transport device that can be used in different printing machines. In addition, a holding device for the printable matter should be provided that makes it possible to always realizing the same conditions for transport of the printable matter.

### OBJECTIVE OF THE INVENTION

Consequently, the invention is based on the objective of additionally developing a device according to the preamble of claim 1 such that a machine configuration with a flexible and improved transport device for printable matter of any type, and in particular, with a preferably linear sheet transport, is achieved without requiring grippers..

This objective is attained with the characteristics disclosed in the characterizing portion of claim 1. The machine configuration makes it possible to transport printable matter that may vary broadly with respect to shape, size and material composition. In this case, renewable holding regions are preferably provided on a conveyor belt as the holding means for sheet-like printable matter. This makes it possible to always realize the same conditions for all sheets to be transported through the printing machine. In addition, it is no longer necessary to generate electrostatic charges. This device is also suitable for various types of printable matter. Advantageous embodiments of the invention are described in the dependent claims, and pertain to holding means in the form of adhesive films, melt-on adhesive regions, variably applicable adhesive strips, offset pressing devices, rolling devices, or timed transport movements of the rollers.

### EMBODIMENTS

The invention is described in greater detail below, with reference to the figures.

The figures show:

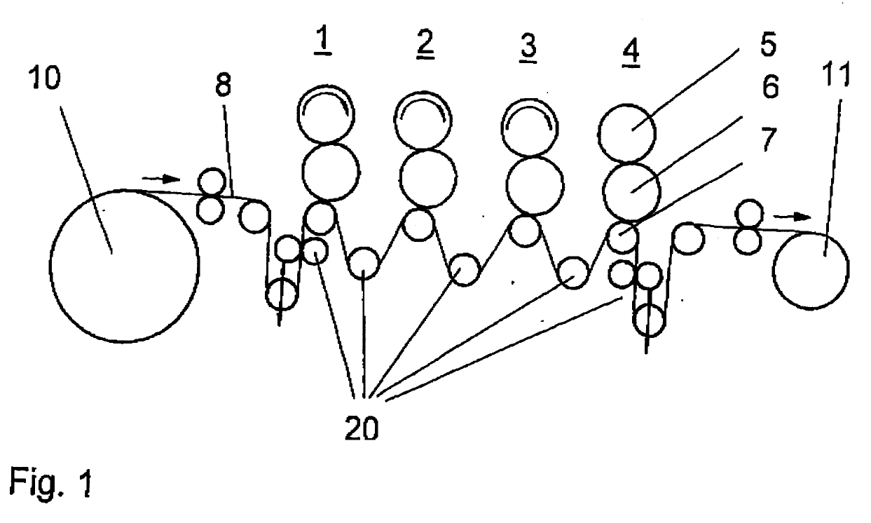

FIG. 1, a web-fed rotary printing machine of standard configuration,

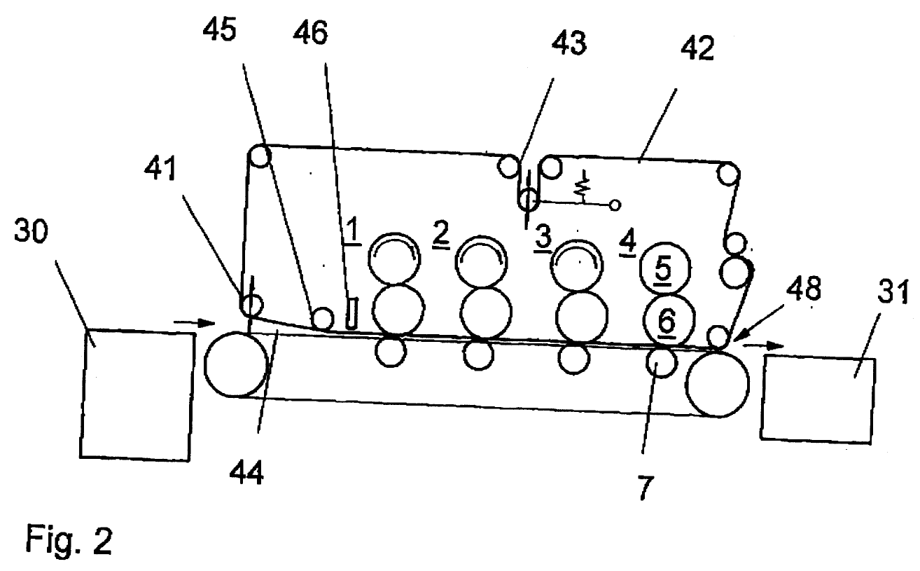

FIG. 2, a printing machine of the same configuration with a conveyor belt and holding bands,

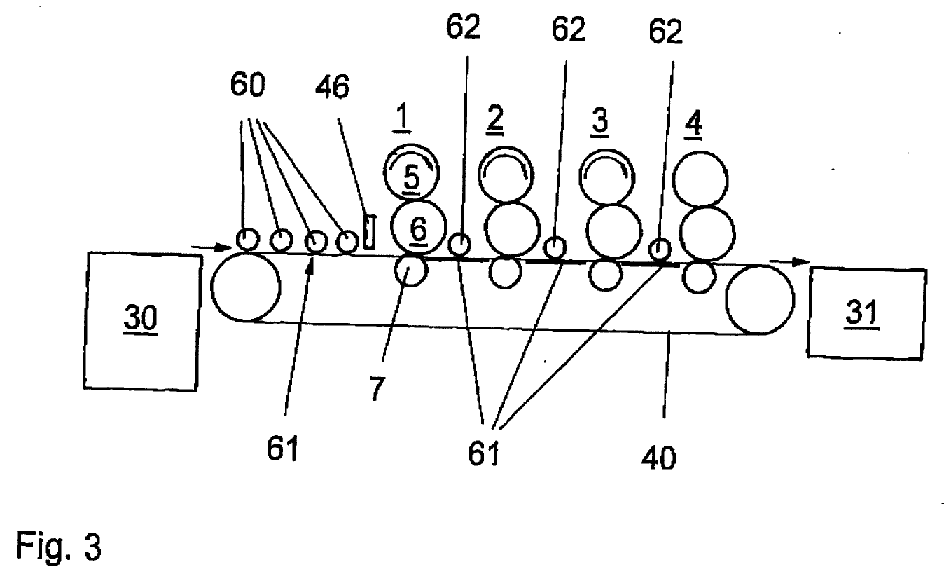

FIG. 3, a printing machine of the same configuration with a conveyor belt and pressing rollers,

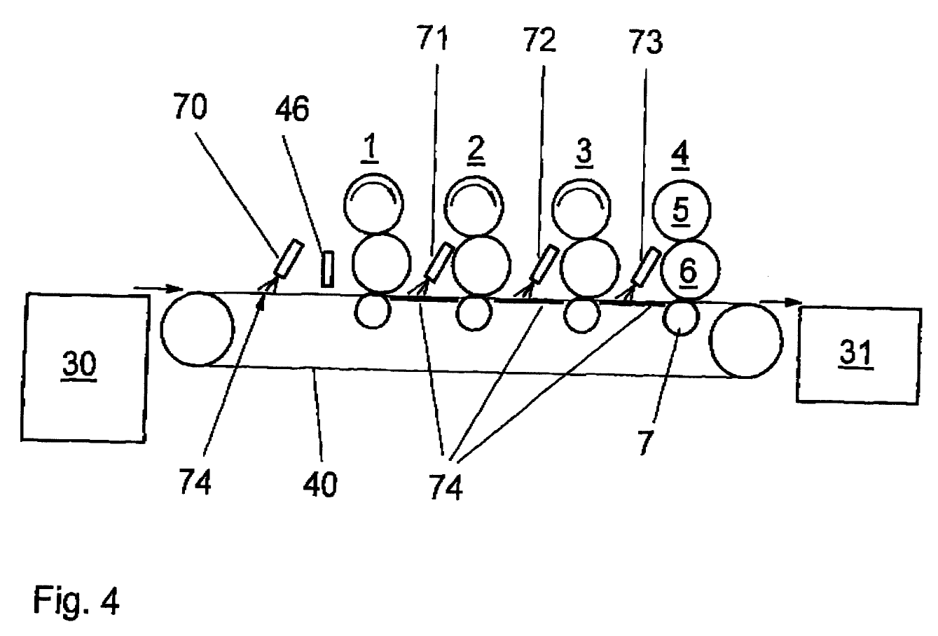

FIG. 4, a printing machine of the same configuration with a conveyor belt and a pneumatic pressing device, and

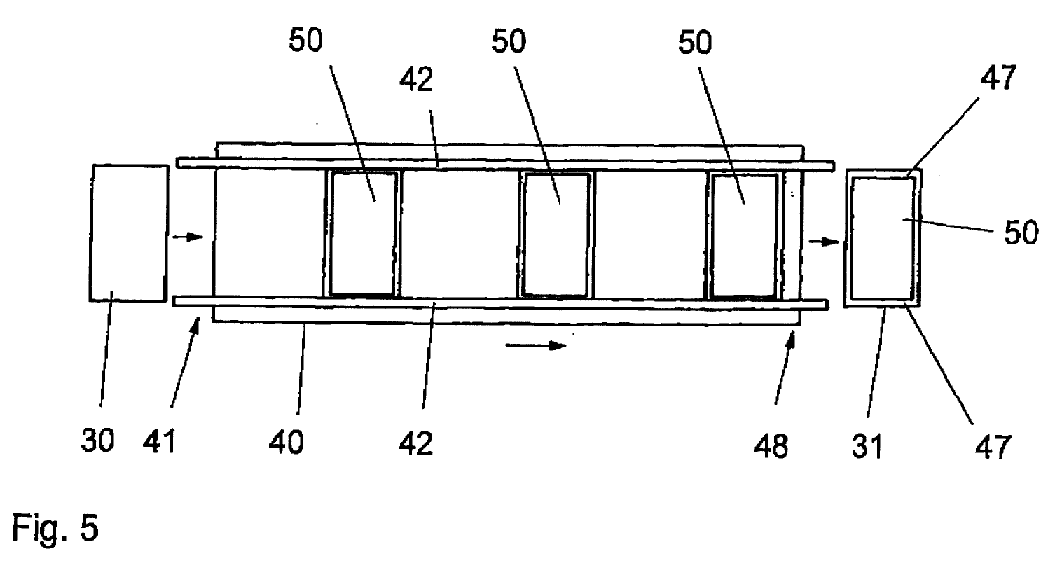

FIG. 5, a top view of a printing machine according to FIG. 2.

FIG. 1 shows a web-fed rotary printing machine with several printing units 1-4, the basic configuration of which comprises an impression cylinder 7, a blanket cylinder 6 and a plate cylinder 5. The web 8 of printable matter is unwound from a supply roll 10 and transported to the impression cylinder 7 of the printing unit 1, with the web being printed in this printing unit by means of the blanket cylinder 6 and then transported to the next printing unit 2 via a deflection roller 20. This process continues analogously until all print images are printed on the web in the printing units 1-4. In the described embodiment, the web 8 of printable matter is transported to a take-off roller 11 and wound up again.

This means that the described printing machine consists of an offset printing machine. However, the printing machine according to FIG. 1 does not contain so-called blanket-to-blanket printing units. In this case, each printing unit 1-4 is respectively provided with an impression cylinder 7 that merely serves to press the printable matter against the printing cylinder, in this case, the blanket cylinder 6. Such a simple configuration of a web-fed rotary printing machine has not been disclosed thus far because the printing units 1-4 usually are always equipped for a double-sided printing process. For reasons of simplicity, the impression cylinders 7 have a smaller diameter than the blanket cylinders 6 and the plate cylinders 5. This is possible because each impression cylinder 7 merely fulfills a support function. The proper registration of the print images in the various printing units 1-4 can be realized with the aid of deflection rollers 20 or other devices, e.g., so-called web tensioning devices.

FIG. 2 shows a printing machine that has the same basic configuration as that shown in FIG. 1. In this case, a generally known conveyor belt 40 for printable matter is guided over the region of the impression cylinders 7. The conveyor belt 40 extends along a plane path through the printing zones of all printing units 1-4, namely between the respective blanket cylinders 5 and the impression cylinders 7. Printable matter in the form of webs or sheets can be placed on this conveyor belt 40.

Sheets of printable matter are fed to the conveyor belt 40 from a feed station 41 arranged in front of the printing unit 1, with said sheets being removed from the feed stack by means of a sheet feeder 30. The sheets are removed from the conveyor belt 40 at a delivery station 48 and placed onto a stack by means of a sheet delivery mechanism 31. The sheets of printable matter are held on the conveyor belt 40 with suitable means while they pass through the printing zones of the printing units 1-4.

Webs of printable matter can be processed similarly. When printing a web of printable matter by means of one-sided printing units, e.g., as in the embodiment shown, problems in guiding the printable matter may arise because the printable matter only adheres to a printing cylinder with one side in the printing zone. This problem can be easily eliminated by providing a suitable guide on the conveyor belt 40.

In FIG. 2, the printable matter is held on the conveyor belt 40 by means of holding bands 42. For this purpose, the conveyor belt 40 and the holding bands 42 are guided parallel to one another in the region in which the printable matter passes through the printing units. The holding bands 42 are returned above the printing units 1-4, in a closed circuit. Tensioning devices 43 may be provided in the region of the holding bands 42. The printable matter is transported by providing a timed catch roller for the holding bands 42 that can be moved in the vertical direction at the beginning of the conveyor belt 40. This makes it possible to produce an inlet gap 44 at the feed station 41 for the printable matter to be transported, such that the printable matter can be inserted between the holding bands 42 and the conveyor belt 40 in a controlled and adjustable fashion. After the printable matter is sufficiently far inserted, the holding bands 42 are lowered and take hold of the printable matter such that it is held onto and transported along with the conveyor belt 40 due to the frictional engagement. A guide roller 45 arranged at the end of the inlet gap 44 feeds the printable matter to the conveyor belt 40 correctly and places the printable matter on the conveyor belt 40 such that it can be printed. The holding band or the holding bands 42 can be realized in the form of magnetic bands. These magnetic bands cooperate with corresponding counter surfaces of the conveyor belt 40. A secure frictional engagement between the printable matter and the conveyor belt 40 is achieved in this fashion. The printable matter is fixed on the conveyor belt 40 and can then be safely guided through the printing units 1-4 along a straight and planar transport path.

A station 46 is provided in order to influence the transport of the printable matter. This station can be realized in the form of a measuring device and/or aligning device 46 or in the form of an electrostatic device. The position of the printable matter is detected at this station, with the printable matter being aligned or electrostatically charged or discharged. All of these measures promote an orderly printing process.

FIG. 5 shows a top view of the transport path of the sheets 50 of printable matter through the printing machine shown in FIG. 2. The holding bands 42 are placed laterally on the sheets 50 of printable matter. In this case, the sheets 50 are held on edges 47 that are not provided with a print image, while the regions to be printed in the center of the sheets 50 of printable matter remain uncovered. It would also be conceivable to place the holding bands 42 in the center of the transport path if non-printed regions are situated at this location in the print image.

FIG. 3 shows a printing machine of the same basic configuration as that shown in FIG. 1. In this case, special conveyor belts 40 are provided, with pressing rollers 60 being arranged opposite these conveyor belts. The printable matter is rolled onto the conveyor belts 40 by means of the pressing rollers 60 and fixed thereon in this fashion. The holding force of the conveyor belts 40 relative to the printable matter can be advantageously influenced by choosing the material of the conveyor belts 40 accordingly. Depending on the printable matter, different materials can be considered for the conveyor belts 40. The pressing rollers 60 cooperate with a rigid counter surface 61 and serve to express any air situated between the printable matter and the conveyor belt 40. When using film-like materials, it usually suffices to provide an equally smooth conveyor belt 40. In this case, sufficient adhesion is achieved when pressing the printable matter onto the conveyor belt by means of the pressing rollers 60. When processing paper-like printable matter, it is advantageous to provide an adhesive film on the conveyor belt 40 in order to additionally increase the holding force.

With respect to the described configuration, it may be advantageous to effect a charge equalization of the printable matter or to charge the printable matter before it is fed to the first printing unit 1. An electrostatic charging device can be used for this purpose. Before being fed to the first printing unit 1, the position of the printable matter needs to be detected and corrected if required. This can be achieved by means of the guidance of the conveyor belt 40. The conveyor belt 40 can be adjusted in the longitudinal and in the lateral direction as it passes through the printing units 1-4.

In order to ensure adhesion to the conveyor belt 40, the printable matter can also be pressed onto the conveyor belt 40 in a correctly registered fashion between the printing units 1-4 by means of additional pressing rollers 62. The guide surfaces 61 provided underneath the conveyor belt 40 serve to achieve an intimate contact with the printable matter. The pressing rollers 62 should be provided with an ink-rejecting surface in this case. However, it would also be conceivable, by means of the pressing rollers 62, to introduce drying substances into the print image produced on the printable matter.

FIG. 4 shows another printing machine of the same configuration as that shown in FIG. 1. In this case, the printable matter is held on the conveyor belt 40 by means of an air current. For this purpose, a pneumatic pressing device 70 is provided upstream of the printable matter inlet into the printing zone of the first printing unit 1. This pneumatic pressing device can be realized in the form of a slot-shaped blower that extends over the entire width of the printable matter. The pneumatic pressing device 70 should be able to generate a very high pressure. It would also be possible for the pneumatic pressing device 70 to move over the printable matter outward from the center. In this case, it may be advantageous to contour the pneumatic pressing device 70 in the transport direction of the printable matter such that, for example, an approximately arrow-shaped arrangement pointing opposite to the transport direction is realized.

Additional pneumatic pressing devices 71, 72 and 73 are also provided for maintaining adhesion between the printing units 1-4. These pressing devices 71-73 make it possible to restore the possibly-diminished adhesion in the printing zones. This is particularly advantageous because the pneumatic pressing devices 71-73 operate in a contactless fashion and consequently cannot smear the fresh print images. An intermediate drying of the print images can also be realized by means of the pneumatic pressing devices 71-73. In this case, it is practical to supply the pneumatic pressing devices 71-73 with pre-heated air.

The adhesion of the printable matter to the conveyor belt 40 can also be increased with additional means, e.g., a detachable adhesive. In this respect, it would be possible to arrange a station for joining the printable matter to the conveyor belt 40 in the feed region of the printable sheets, wherein regions provided with an adhesive bond are arranged in the conveyor belt 40. These regions can be melted with the aid of a heating station to take hold of the surface of the printable matter such that the printable matter adheres particularly well to the conveyor belt. The delivery of the printable matter at the delivery station is achieved by heating the-adhesive regions once again. This type of adhesive bond advantageously makes it possible to join the printable matter and the conveyor belt 40 under conditions that are practically always identical. The alternative and cost-efficient utilization of conventional adhesive strips from which paper-like printable matter can, for example, easily be removed again, is variable as a function of time, and cannot be easily renewed. The option of melting on adhesive regions always provides the same adhesive conditions during transport of the printable matter.

The devices shown also make it possible to process sheet-type printable matter in a printing machine that is configured for web-type printable matter. All variations of attaching the printable matter to the conveyor belt 40 are advantageous with respect to the fact that they always provide identical adhesive conditions. When utilizing electrostatic charges, or if only regions coated with an adhesive are provided, the adhesive conditions cannot be easily renewed. In addition, these options are not even suitable for certain printing methods, e.g.,.the wet offset printing method. The renewability of the adhesive conditions is accomplished, for example, by constant cleaning the adhesive films, thus keeping them free of paper dust. The melt-on adhesive also provides identical adhesive conditions at all times. Adhesion of the printable matter can be constantly monitored, and restored if so required, by means of the pressing rollers 60, 62 and the pneumatic pressing devices 70-73.

The printing machine described can be used for all printing methods known so far. This means that, in particular, limitation to conventional offset printing does not apply in this case. Also, the transport of the printable matter is not limited to conventional printing methods. On the contrary, it can be utilized in all methods including planographic printing, rotogravure printing and letterpress printing. In this. respect, it is possible to carry out direct and indirect printing methods. Digital printing methods in which printing plates are produced in the machine can also be considered. Various inking methods can be used in the printing machine, with the orientation taking place according to the required printing quality. Inking methods used in the field of sheet printing can be used with equal success as inking methods known from the field of a web-fed printing. The utilization of special inking methods that are based on toners in dry or liquid form would also be conceivable, in particular, in digital printing machines.

The printing machine can also be designed in accordance with current construction principles, wherein the utilization of sleeve-shaped printing plates or blankets or other cylinder linings can be considered.

With respect to the machine configuration, it would be possible to realize an embodiment in which the cylinders that form the printing gaps can be adjusted relative to one another linearly or in the shape of an arc. This provides the advantage that assignment of the printing elements can be easily realized. In this case, the printing units do not have to be refitted when the printing method or the type of printable matter is changed.

In this context, the utilization of individual drives for all known printing unit elements is particularly advantageous. It would be conceivable to drive the sheet feeder 30 separately. This makes it possible to transport sheets of printable matter to the printing machine in a much more targeted fashion.

Printing processes for web-type printable matter that are not dependent on the format can also be realized in this case. Printing processes with a not-completely-covered plate cylinder can be controlled in such a way that the web of printable matter is printed over its entire length. In this case, the printable matter can simply be moved in cycles. Although the plate cylinders rotate steadily, the conveyor belt is moved only when a print image needs to be transferred. The conveyor belt is at a standstill when the circumferential sections of the plate cylinder that are not covered with print images rotate past the printable matter. This means that no gaps that would unnecessarily increase the consumption of printable matter are formed between the print images. This method is particularly suitable for a printing process carried out on the previously described printing machine with a conveyor belt. The web of printable matter can be guided very precisely and controlled almost arbitrarily once it is placed onto the conveyor belt. The registration stability of the print images in the individual printing units is always ensured because the conveyor belt guides the web of printable matter. When processing web-type printable matter, the described auxiliary means for producing the connection between the printable matter and the conveyor belt during transport of printable matter can be utilized as described above with reference to sheet-type printable matter.

List of Reference Symbols

Printing unit 1

Printing unit 2

Printing unit 3

Printing unit 4

Plate cylinder 5

Blanket cylinder 6

Impression cylinder 7

Web of printable matter 8

Feed roller 10

Take-off roller 11

Deflection roller 20

Sheet feeder 30

Sheet delivery mechanism 31

Conveyor belt 40

Feed station 41

Holding bands 42

Tensioning device 43

Inlet gap 44

Guide roller 45

Measuring and aligning device 46

Electrostatic device 46

Edge of printable matter 47

Delivery station 48

Sheet of printable matter 50

Pressing rollers 60

Guide surface 61

Pressing roller 62

Pneumatic pressing device 70

Pneumatic pressing device 71

Pneumatic pressing device 72

Pneumatic pressing device 73

Guide surface 74

1. Printing machine for printing multicolor print images on printable matter, with a series of printing units that respectively contain at least one plate cylinder, an inking system, and an impression cylinder, and with a system for guiding the printable matter through all printing units (1-4) in a detachably connectable fashion, wherein a plane that is defined by the impression cylinders (7) and in which the printable matter is transported extends linearly through the printing units (1-4), and wherein the system for guiding the printable matter is preferably realized in the form of a belt or band, characterized by the fact that the system for guiding the printable matter is able to transport sheet-type and/or web-type printable matter through all printing units (1-4), by the fact that the impression cylinders (7) have a diameter that is not dependent on the diameter of the plate cylinder (5), and by the fact that the cylinders that form the printing gap, through which the printable matter guiding system is led, can be adjusted relative to one another linearly or in the shape of an arc.

2. Printing machine according to claim 1, characterized by the fact that the system for guiding the printable matter contains a feed station (41) for supplying web-type or sheet-type printable matter and/or a delivery station (48) for delivering the printable matter.

3. Printing machine according to claim 1 or 2, characterized by the fact that the system for guiding the printable matter contains means for securing the printable matter in position with correct registration during its transport.

4. Printing machine according to claim 3, characterized by the fact that the system for guiding the printable matter contains a conveyor belt (40) that extends in a planar or approximately planar fashion through the printing zones assigned to the impression cylinders (7) of all printing units (1-4), and by the fact that means for securing the printable matter are provided on the conveyor belt.

5. Printing machine according to claim 4, characterized by the fact that in the system for guiding the printable matter a device for increasing the adhesiveness of the conveyor belt (40) relative to the printable matter is assigned to the conveyor belt (40) in the vicinity of the feed station (41), and a device for reducing the adhesiveness of the conveyor belt (40) relative to the printable matter is assigned to the conveyor belt (40) in the vicinity of the delivery station (48).

6. Printing machine according to claim 3, 4 or 5, characterized by the fact that pneumatic pressing devices (70-73) are used as the means for securing the printable matter and are arranged along the transport path thereof.

7. Printing machine according to claim 3, 4 or 5, characterized by the fact that pressing rollers (60,62) are used as the means for securing the printable matter and are arranged along the transport path thereof.

8. Printing machine according to claim 5 or 6, characterized by the fact that adhesive regions, the adhesiveness of which can be controlled by the influence of heat, are used as the means for securing the printable matter and are arranged on the conveyor belt (40).

9. Printing machine according to claim 8, characterized by the fact that a device for increasing the adhesiveness of the adhesive regions is arranged in the vicinity of the feed station (41), and by the fact that a device for reducing the adhesiveness of the adhesive regions is provided in the vicinity of the delivery station (48).

10. Printing machine according to claims 5-9, characterized by the fact that devices for increasing the adhesiveness of the conveyor belt (40) relative to the printable matter are provided between the printing units (1-4).

11. Printing machine according to claim 3 or 4, characterized by the fact that pressing devices for producing a frictional engagement between the printable matter and the conveyor belt (40) are provided along the transport path of the printable matter through the printing units (1-4) such that the printable matter is constantly pressed against the conveyor belt (40) outside the regions being printed and the adhesiveness of the conveyor belt (40) relative to the printable matter is constantly increased in the region of the pressing devices.

12. Printing machine according to claim 11, characterized by the fact that holding bands (42) are provided which are assigned to at least the non-printed edges of the printable matter, by the fact that the holding bands (42) are guided parallel to the conveyor belt (40) in the region of the printing zones, by the fact that a holding force can be directly or indirectly exerted upon the printable matter by means of the holding bands (42), and by the fact that the holding bands (42) can be driven synchronously with the conveyor belt (40).

13. Printing machine according to claim 11 or 12, characterized by the fact that a feed gap (44) can be produced between the holding bands (42) and the conveyor belt (40) in the vicinity of the feed station (41) by controlling the guide elements of the holding bands (42), such that the printable matter is fed to the conveyor belt (40) cyclically.

14. Printing machine according to one of the preceding claims, characterized by the fact that the machine is provided with a drive by means of which the system for guiding the printable matter can be driven independently of at least the plate cylinders (5).

15. Printing machine according to claim 14, characterized by the fact that the system for guiding the printable matter can be driven incrementally while the plate cylinders (5) are driven continuously, such that continuous or approximately continuous print images can be printed on the printable matter if the plate cylinder surface is not completely covered.
